(19) United States
(12) Patent Application Publication
(10) Pub. No.: US 2012/0147366 A1
(43) Pub. Date: Jun. 14, 2012

(54) Device and Method for Inspecting Containers

(75) Inventor: Anton NIEDERMEIER, Abensberg Offenstetten (DE)

(73) Assignee: KRONES AG, Neutraubling (DE)

(21) Appl. No.: 13/290,049

(22) Filed: Nov. 4, 2011

(30) Foreign Application Priority Data
Nov. 9, 2010 (DE) 10 2010 050 673.7

(51) Int. Cl. G01N 21/90

(52) U.S. Cl. 356/240.1

(57) ABSTRACT

A device for inspecting containers includes an illumination device that illuminates the containers; a transport device, which transports the containers along a predetermined transport path in relation to the illumination device; at least one first observation device, which observes a first region of the containers and records at least one image of the first observed region; and at least one second observation device, which observes a second region of the containers and records at least one image of the second observed region. At least one part of the illumination device serves both to illuminate the first region of the containers observed by the first observation device and to illuminate the second region of the containers observed by the second observation device. The first observation device and the second observation device record images of the regions of the containers at different positions of the containers along the transport path.

### CROSS-REFERENCE TO RELATED APPLICATION

This application claims the benefit of priority of German Patent Application No. 10 2010 050 673.7, filed Nov. 9, 2010, pursuant to 35 U.S.C. 119(a)-(d), the disclosure of which is incorporated herein by reference.

### TECHNICAL FIELD

The present disclosure relates to a device and a method for inspecting containers.

### BACKGROUND

Inspection machines for inspecting containers have been known for some time in the prior art. Such inspection machines or devices for containers typically have different detection devices. It is for example possible for the mouth orifice of the container to be examined, but it would also be conceivable for the side wall of the container to be examined (such as for weaknesses) or also the base of the container (for example for foreign bodies in the container).

DE 100 65 290 C2 discloses a method and a device for optical inspection of bottles. Illumination units are provided which are arranged in the vicinity of a mouth orifice area and/or the bottle base. Furthermore this device has a rejection station to reject soiled or defective bottles.

DE 690 217 53 T2 discloses a method and a device for inspecting an object or a series of objects supplied in succession. An inspection is carried out on the basis of bright field illumination and the use of a first type of electromagnetic radiation, and then an inspection based on dark field illumination using a second type of electromagnetic radiation.

DE 100 171 26 C1 describes a method and a device for optical checking of transparent containers. The containers are exposed to light from an illumination device and images are produced at least of container parts.

For such inspection devices, the compactness and length of the machine or device is often decisive for whether the machine or device is easy to integrate in plants. Correspondingly larger treatment machines are in principle more costly.

In the case of container inspection too, different inspection tasks which cannot be handled by the same optical configuration are located to the same position in favour of compactness. Different optical configurations can for example mean the same illumination but different lenses. Thus with the same illumination below the container base, firstly an inspection is performed of the base using one camera through the bottle mouth and then of the bottle inside wall using a second camera. In practice beam splitters are used here which are positioned over the bottle mouth. The beam splitter can be part of a lens of an optical arrangement or be integrated in a lens system. Two individual lenses can be present which are connected after the beam splitter. It would also be possible to provide further beam splitters i.e. to split further the beam already split in order for example to carry out a mouth orifice inspection and then split further to perform an infrared residual fluid detection. Here as well as beam splitters where applicable additional filters are used which separate infrared light from visible light.

These embodiments however have the disadvantage that for individual detection the relevant signal must pass through at least one beam splitter and in principle is attenuated as a result. For reliable inspection however a minimum signal strength is required. This is for example possible with a stronger transmitter i.e. a stronger illumination. Stronger illumination however is substantially more cost intensive than simple illumination.

It may therefore be desirable to provide a suitable method and arrangement which avoids the said disadvantages without however significantly enlarging the inspection devices or machines.

### SUMMARY

According to various aspects of the disclosure, a device for inspecting containers has an illumination device which illuminates the containers. Furthermore the device has a transport device which transports the containers along a predetermined transport path in relation to the illumination device. In addition at least one first observation device is provided which observes a first region of the containers and records at least one image of the observed first region. Furthermore at least one second observation device is provided which observes a second region of the containers and records at least one image of the second zone observed, wherein at least one part of the illumination device serves both to illuminate the first region of the container observed by the first observation device and to illuminate the second region of the containers observed by the second observation device.

According to the invention the first observation device and the second observation device record images of the regions of the containers at different positions of the containers along the transport path.

It is therefore proposed to undertake the detection firstly not at one place but secondly not completely separately at two independent places. Rather the detections or observations of the containers are interlinked such that each acts independently but can use part of the other detection, in particular the illumination device but also parts thereof. In some aspects, one observation device is an observation device which observes a base of the container. In some aspects, one of the observation devices is an observation device which observes a side wall of the container. It is thus proposed that the illumination device is used at least partly to illuminate both regions. In this way the device can be constructed very compactly.

A system is therefore proposed with which two or more inspection systems can be operated. In this way for example a combination of a base inspection, an inner wall inspection, a thread inspection and where applicable a further base inspection is conceivable. In the proposed embodiment an illumination device or lamp could be fitted in a housing, which has cost advantages.

In some aspects, said regions of the containers are observed in the back light method i.e. the containers to be observed are, in some aspects, transported between the illumination device and the observation device.

The containers are in particular bottles such as for example glass bottles and/or plastic bottles. Where applicable the device could also be used to inspect plastic preforms which are later formed into plastic containers. In some aspects, the first region is a base area of the containers and the second region an inner side wall area of the containers.

In an exemplary embodiment a first observation path along which the first observation device observes the containers is totally separate from a second observation path along which the second observation device observes the containers. It is therefore proposed that the two observation paths are designed, in some aspects, without beam splitters. In this way the complete illumination power of individual segments is available for the respective operation process.

In some aspects, the first observation path and the second observation path are virtually parallel to each other. This means in particular that at least one axis of symmetry of the first observation path and one axis of symmetry of the second observation path are parallel to each other.

In an exemplary embodiment the observation devices are arranged in direct succession along the transport path of the containers. It is possible that these observation devices are arranged in a common housing. It would however also be possible for the observation devices to have separate lenses.

In an exemplary embodiment the illumination device has several illumination segments, wherein at least one illumination segment serves to illuminate both regions of the containers. It is for example possible for the illumination device to have three illumination segments arranged in succession in the transport direction of the containers, wherein for the first observation the first and second segments are activated and for the second observation the second and third segments. It would also be possible for the illumination segments to emit different light wavelengths. In some aspects, the illumination segments have one or a multiplicity of light sources which perform the illumination.

In an exemplary embodiment the illumination device is arranged below the containers. This means that the containers are illuminated from below. It is for example possible for the transport device to guide the containers over a transparent plate or for the containers to be transported suspended for example from a carrier ring.

In an exemplary embodiment at least one observation device and, in some aspects, both observation devices are arranged above the containers. The observation paths run, in some aspects, substantially parallel to a longitudinal axis of the container to be observed. In some aspects, the observation takes place in a substantially vertical direction.

In an exemplary embodiment the illumination device comprises a base segment which serves for observation with two observation devices and at least one additional segment which serves for observation with just one of the two observation devices. Here it is in some aspects possible for the illumination device to be modular in structure and able to be expanded by further illumination segments depending on the requirements. Thus the illumination device could be constructed for example in the manner of a push-fit set where further illumination segments can be added as required.

As well as the first and second observation device, further observation devices can be provided in order to be able to perform simultaneously more than two inspection tasks (base inspection, side wall inspection, mouth inspection etc.). The illumination device can be used for all inspection tasks. The illumination device can also be formed in the manner of an illumination running surface, wherein the illumination moves with the transported containers. In addition the geometric shape of the illumination can change, for example from circular illumination to rectangular illumination.

The present invention is furthermore based on a method for inspecting containers wherein an illumination device illuminates the containers and a transport device transports the containers along a predetermined transport path in relation to the illumination device. Furthermore a first observation device observes a first region of the containers and records at least one image of the observed first region and a second observation device observes a second region of the containers and records at least one image of the second observed region. Here at least one part of the illumination device serves both to illuminate the first regions of the containers observed by the first observation device and to illuminate the second regions of the containers observed by the second observation device.

According to the invention the first observation device and the second observation device record images of the regions at different positions of the containers along the transport path.

In some aspects, the two observation devices record images of the same container at different times. Thus it is possible that the image recording by the observation devices is triggered depending on a position of the container. In an exemplary method the observation devices record images triggered by the location of the containers inspected. It would also be possible that the two observations or image recordings are triggered at different times in succession as a function of transport speed of the containers.

In some aspects, the two observations paths are arranged at a distance from each other which is less than 50 cm, in some aspects less than 40 cm, in some aspects less than 30 cm, in some aspects less than 20 cm, and in some aspects less than 15 cm.

Further advantages and embodiments may arise from the enclosed drawings.

### BRIEF DESCRIPTION OF THE DRAWINGS

In the figures:

FIG. 1 illustrates a device for inspecting containers according to the prior art, and

FIG. 2 is a diagrammatic depiction of an exemplary device according to various aspects of the disclosure for inspecting containers.

### DETAILED DESCRIPTION

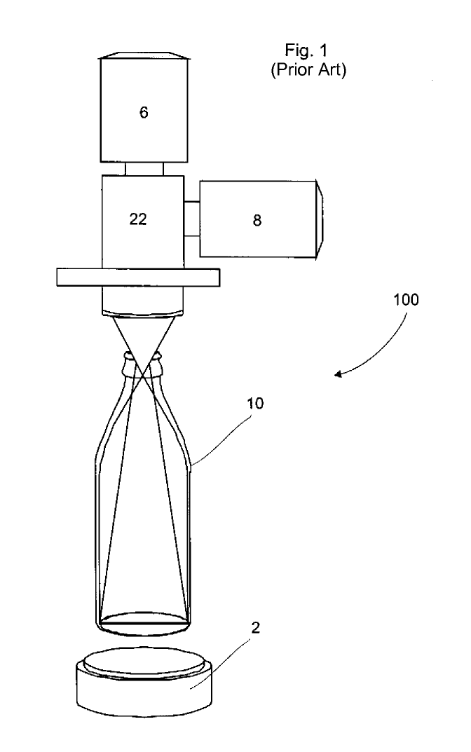

FIG. 1 shows a device 100 from the prior art for inspecting containers. Containers 10 are illuminated by means of an illumination device 2 and observed with two observation devices 6 and 8. Reference numeral 22 indicates a beam splitter device which splits the light leaving the container onto the two observation devices 6 and 8. The illumination device 2 must here be designed sufficiently strong for the light, despite beam splitting, to still be sufficient to allow both observation devices 6 and 8 to record a suitable image of the container.

In this case a special lens is provided which contains said beam splitter 22.

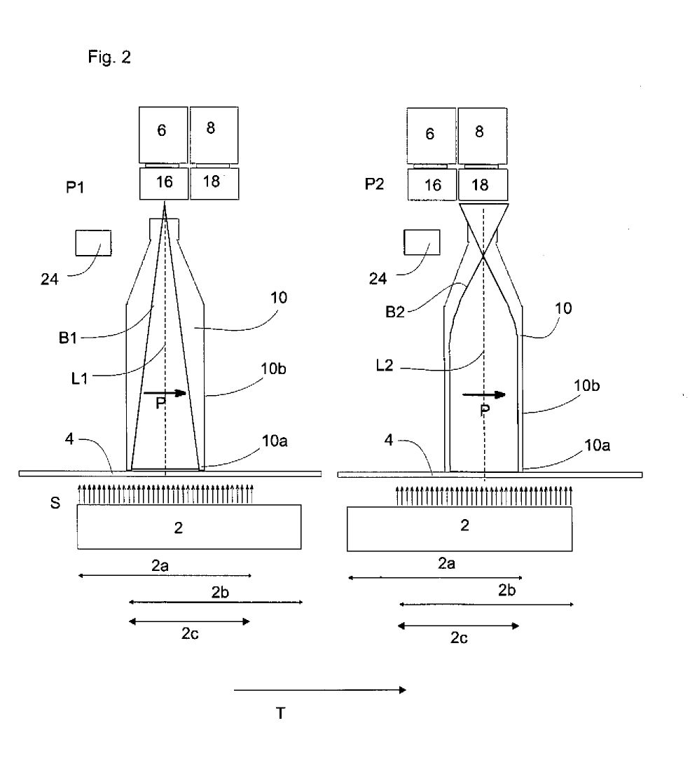

FIG. 2 shows a diagrammatic depiction of a device according to the invention. Here again an illumination device 2 is provided which serves to illuminate the containers 10 or both the base 10a of the containers and the inner wall 10b of the containers. Furthermore a transport device 4 is provided which transports the containers along transport path T. The two depictions shown in FIG. 2 shows two image recording situations. In the left part figure, the observation device 6 records an image of container 10 via lens 16 and in the right part figure the observation device 8 records an image of the container via lens 18. The observation device 6 and, in some aspects, also the observation device 8 look through a mouth orifice into the inside of the container.

Reference numeral B1 indicates accordingly the observation path below which the first observation device observes the container base 10a, and reference numeral B2 indicates the observation path below which the second observation device 8 observes the container inner wall 10b. The vertical line L1 indicates an axis of symmetry of the observation path B1 and here coincides with a longitudinal direction of the container. Correspondingly reference numeral L2 in the right part figure designates an axis of symmetry of observation path B2 and here too coincides with the longitudinal direction of the container. Thus the two axes of symmetry L1 and L2 are parallel to each other.

The inspection of the base 10a and the inspection of the inner side wall 10b of the container differ here only in the type of lens 16, 18 used. In the prior art as already stated, a solution was provided with beam splitters or a so-called combination lens. Both detections performed here work, in some aspects, with diffuse illumination from the illumination device 2 arranged below the bottle base 10a. In some aspects, the illumination field of the illumination device is greater than that of the base area to be inspected. In this way the properties of water drops and glass imprints such as the grooved standing area of the base of a glass bottle, are illuminated evenly.

The further the illumination device from the container base 10a, the larger the illumination device 2 should be. In an exemplary embodiment the illumination device for the container base 10a comprises a circular area of for example 120 mm. As shown in the left part of FIG. 2, here not all segments of the illumination device are activated but only the segments which direct light along beam direction S onto the bottle base. Here the illumination device 2 is activated only along length 2a shown.

The illumination device can however assume other geometric shapes such as rectangles or squares. In the prior art an illumination diameter of 120 mm is provided with at least double, usually however because of losses on the beam splitter three times the light intensity.

A further advantage of the common illumination area arises from the common housing of a larger light surface. This firstly prevents the units from fracturing and thus supports hygiene, but secondly with this common housing a cascadable illumination area can be created. Thus a basic illumination area 2a is created to which can be added the area of e.g. 2 minus 2a as an extension illumination. This would naturally also apply to any further station.

With the device according to the invention the base illumination is used only with single intensity and extended in the transport direction T or along transport path P by the distance required for the two camera systems 6 and 8 including their lenses 16 and 18 in succession. In relation to the illumination devices known from the prior art therefore the illumination device 2 shown in FIG. 2 is extended by between 20 and 80 mm, in some aspects, between 30 and 50 mm. In this way a combination of independent detections is achieved without the disadvantage of a beam splitter.

In the right part figure, an image of the container inner wall is recorded by the second observation device 8. Reference numerals P1 and P2 here relate to (different) positions of the container in relation to the illumination device 2 or observation devices 6 and 8. Both the illumination device 2 and the observation devices 2 and 6 are here arranged stationary. Reference numeral 4 indicates purely diagrammatically a transport device which moves the containers. This can for example be a (in some aspects transparent) conveyor belt, but it would also be possible as stated above for the containers not to be guided on the base but for example guided at a neck region. Guidance of the containers on their outer wall, for example via side guide strips, would also be possible.

In the examples shown in FIG. 2, the extent of the illumination device is approximately 120×160 mm, wherein a single beam intensity is used. This means that the illumination device according to the invention would be at least 50% smaller with regard to the product of area and intensity than in the prior art, and yet however need only be imperceptibly longer.

The illumination shown in FIG. 2 can as stated be divided into overlapping illumination segments 2a and 2b, it would however also be possible for the illumination device to be operated as a whole. Reference numeral 2c relates to an overlapping segment which is used for both inspection processes. As stated above here the illumination device 2 can be composed modular from three segments 2a, 2b and 2c.

In some aspects, the illumination device 2 is not operated continuously but pulsed. In some aspects, a position of a container 10 along transport path P is established and at particular positions triggers both the illumination of the illumination devices and the image recording by the observation devices 6 and 8. For each bottle therefore, in some aspects, in temporal sequence two images of the container are recorded, firstly an image of the container base and secondly an image of the container inner wall. Thus in comparison with the prior art the images are recorded in temporal succession. The time interval between the images depends on the transport speed of the container 10 along transport path P. It would also be possible to use different wavelengths in the individual but overlapping illumination segments. It would also be possible for a part illumination to be a subset of the other part illumination. This entails the advantage that it is never necessary to activate the entire illumination area and consequently the power supply need only be dimensioned for approximately ⅔ of the illumination area.

The device can furthermore comprise position detection devices 24 such as for example light barriers which determine a position of the containers in relation to the observation devices 6, 8. Image recording by the observation devices 6, 8 can be triggered in response to a signal from the position detection device. In some aspects, the transport device transports the containers at a prespecified distance from each other. This distance is between 1 and 20 cm, in some aspects, between 2 and 15 cm, and in some aspects, between 3 and 15 cm. The illumination device can furthermore have a scatter device (not shown) to generate diffuse light.

It will be apparent to those skilled in the art that various modifications and variations can be made to the device and method for inspecting containers of the present disclosure without departing from the scope of the invention. Throughout the disclosure, use of the terms “a,” “an,” and “the” may include one or more of the elements to which they refer. Other embodiments of the invention will be apparent to those skilled in the art from consideration of the specification and practice of the invention disclosed herein. It is intended that the specification and examples be considered as exemplary only.

What is claimed is:

1. Device for inspecting containers, comprising:
an illumination device which illuminates the containers;
a transport device, which transports the containers along a predetermined transport path in relation to the illumination device;
at least one first observation device, which observes a first region of the containers and records at least one image of the first observed region; and
at least one second observation device, which observes a second region of the containers and records at least one image of the second observed region,
wherein at least one part of the illumination device serves both to illuminate the first region of the containers observed by the first observation device and to illuminate the second region of the containers observed by the second observation device, wherein the first observation device and the second observation device record images of the regions of the containers at different positions of the containers along the transport path.

2. Device according to claim 1, wherein the observation devices are arranged in direct succession along the transport path of the containers.

3. Device according to claim 1, wherein the illumination device comprises several illumination segments, wherein at least one illumination segment serves to illuminate both regions of the containers.

4. Device according to claim 1, wherein the illumination device is arranged below the containers.

5. Device according to claim 1, wherein a first observation path along which the first observation device observes the containers and a second observation path along which the second observation device observes the containers are completely separate.

6. Device according to claim 5, wherein the first observation path and the second observation path are parallel to each other.

7. Device according to claim 1, wherein the at least one first observation device is arranged above the containers.

8. Device according to claim 7, wherein the at least one second observation device is arranged above the containers.

9. Device according to claim 1, wherein the at least one second observation device is arranged above the containers.

10. Device according to claim 1, wherein the illumination device comprises a base segment, which serves for observation with both observation devices, and at least one additional segment, which serves for observation with only one of the two observation devices.

11. Method for inspecting containers, comprising:
transporting the containers along a predetermined transport path in relation to an illumination device;
observing a first region of the containers with a first observation device and recording at least one image of the observed first region at the first observation device;
observing a second region of the containers with a second observation device and recording at least one image of the observed second region at the second observation device; and
illuminating both the first regions of the containers observed by the first observation device and the second regions of the containers observed by the second observation device with at least one part of the illumination device,
wherein the first observation device and the second observation device record images of the regions of the containers at different positions of the containers along the transport path.

12. Device for inspecting containers, comprising:
an illumination device configured to illuminate the containers;
a transport device configured to transport the containers along a predetermined transport path in relation to the illumination device;
at least one first observation device configured to observe a first region of the containers and records at least one image of the first observed region; and
at least one second observation device configured to observe a second region of the containers and records at least one image of the second observed region,
wherein at least one part of the illumination device is structured and arranged both to illuminate the first region of the containers observed by the first observation device and to illuminate the second region of the containers observed by the second observation device, and
wherein the first observation device and the second observation device are configured to record images of the regions of the containers at different positions of the containers along the transport path.
